(19) United States
(12) Patent Application Publication
(10) Pub. No.: US 2006/0205410 A1
(43) Pub. Date: Sep. 14, 2006

(54) Method and system of controlling operation of customer access point with remote control

(75) Inventor: Neville A. Black, Collegeville, PA (US)

Correspondence Address: BROOKS KUSHMAN P.C., 1000 TOWN CENTER, TWENTY-SECOND FLOOR, SOUTHFIELD, MI, 48075, US

(73) Assignee: Comcast Cable Holdings, LLC, Philadelphia, PA (US)

(21) Appl. No.: 11/075,100

(22) Filed: Mar. 8, 2005

(51) Int. Cl. H04Q 7/20

(52) U.S. Cl. 455/445

(57) ABSTRACT

A method and system of controlling a customer access point with a remote control. The method and system including displaying control features on a user interface of the remote control for use in controlling operation of the customer access point.

### BACKGROUND OF THE INVENTION

1. Field of the Invention

The present invention relates to methods and system of controlling operation of customer access points with a remote control.

2. Background Art

Cable, telecommunication, and other system operators provide a number of services to their customers, including television, video on demand (VOD), digital video recording (DVR), high speed data/internet services and the like. The access point for these services typically is a unit at the customer location, such as a settop box (STB), media terminal adapter (MTA), outlet digital adapter (ODA), cable modem, computer, or the like.

Such access points may include an electronic programming guide (EPG), a graphically user interface (GUI), or other user navigable interfaces or menus for manipulating the services. In some cases, the access points may be controllable with signals received from a remote control. For example, STBs may be programmed to display an EPG on a television and permit a user to navigate through the EPG with remote control signals.

One problem with such access points and user interfaces is that the features are user generic in the sense that the same menus are shown regardless of the user accessing the services. Another problem with such access points and user interfaces is that they may require a user to be in close proximity to the display in order to view the information associated therewith and/or to communicate signals thereto with the remote control.

### SUMMARY OF THE INVENTION

One non-limiting aspect of the present invention relates to a method and system of providing user specific interfaces for use in controlling operation of customer access points.

One aspect of the present invention relates to a system of providing services to a customer access point. The system may include a provider configured to transmit television, telephony, high speed data, and other service related signals to the customer access point. The system may further include a remote control configured to remotely control operation of the customer access point according to user inputs received through a remote control user interface.

In accordance with one non-limiting aspect of the present invention, the provider may be configured to transmit interface signals for controlling information displayed on the remote control user interface such that the inputs received through the remote control user interface to control operation of the customer access point are a function of the interface signals transmitted by the provider.

In accordance with one non-limiting aspect of the present invention, the customer access point may be a settop box (STB) such that channels tuned to by the STB are controlled according to inputs received by the remote control interface. Optionally, the STB may include a digital video recorder (DVR) such that recording on the DVR may be controlled by the remote control.

In accordance with one non-limiting aspect of the present invention, the remote control may be a mobile/cellular phone, television remote control, personal digital assistant (PDA), or the like.

One aspect of the present invention relates to a method of controlling a settop box (STB). The method may include providing user interface signals to a mobile phone for displaying a user interface on the mobile phone through which a user selects inputs for controlling operation of the STB.

In accordance with one non-limiting aspect of the present invention, the method may further comprise transmitting signals from the mobile phone to control a channel tuned to by the STB or to control programs recoded on a recorder associated with the STB.

In accordance with one non-limiting aspect of the present invention, the method may further comprise automatically customizing the user interface based on a user of the mobile phone so as to customize the user interface to the user.

One aspect of the present invention relates to a method of selecting programs for viewing on a television. The method may include providing signals to a mobile phone having a user interface for displaying a menu on the mobile phone interface through which a user selects a program for viewing on the television.

In accordance with one non-limiting aspect of the present invention, the method may further comprise providing the signals to the mobile phone over a mobile phone network or a settop box (STB) associated with the television.

In accordance with one non-limiting aspect of the present invention, the method may further comprise customizing the menu to the user based on signals emitted from the mobile phone, such as based on a telephone number associated with the mobile phone.

In accordance with one non-limiting aspect of the present invention, the method may further comprise transmitting a control signal from the mobile phone to tune the television to the selected program based on inputs received through the mobile phone interface, such as by transmitting the signal from the mobile phone by way of a mobile phone network to a settop box (STB) associated with the television and/or transmitting the control signal from the mobile phone directly to the STB.

One aspect of the present invention relates to a method of operating a customer access point. The method may include associating a remote control configured to transmit signals to facilitate control of the customer access point with a user and controlling a service associated with the customer access point as a function of the user associated with remote control.

In accordance with one non-limiting aspect of the present invention, the method may further comprise displaying a user interface on the remote control to facilitate transmitting signals from the remote control for controlling the customer access point.

The above features and advantages, along with other features and advantages of the present invention, are readily apparent from the following detailed description of the invention when taken in connection with the accompanying drawings.

### BRIEF DESCRIPTION OF THE DRAWINGS

FIG. 1 illustrates a system of providing services to customer access points in accordance with one non-limiting aspect of the present invention.

### DETAILED DESCRIPTION OF THE PREFERRED EMBODIMENT(S)

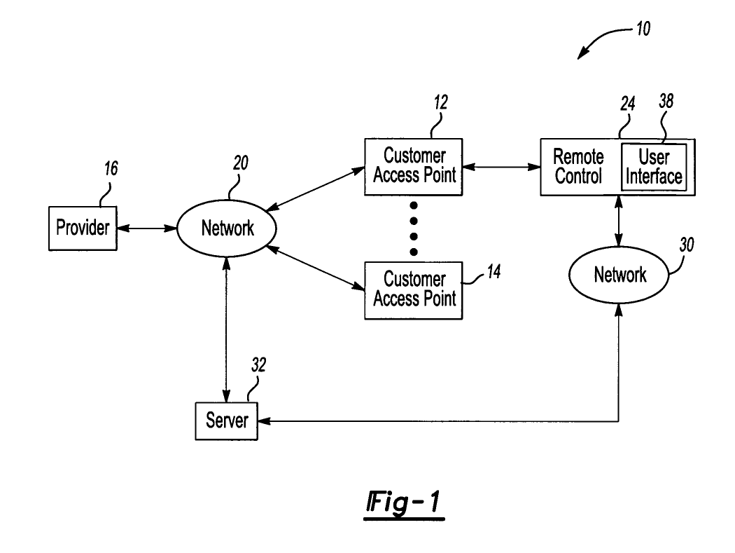

FIG. 1 illustrates a system 10 of providing services to customer access points 12-14 in accordance with one non-limiting aspect of the present invention. The system 10 generally relies upon mono or bi-directional communication of service related signals between a service provider 16 and the customer access points 12-14.

The system 10 may be associated with any number of customer service operators, including cable and telecommunication operators. The system 10 may be configured to provide any number of services, such as television, telephony, high speed data, and the like.

The customer access points 12-14 may include any number of configurations and features, including settop boxes (STBs), outlet digital adapters (ODA), media terminal adapters (MTA), voice over internet protocol (VoIP) units, digital video recorders (DVR), computers, modems, and other devices capable of providing services to customers.

The customer access points 12-14 may communicate with the provider 16 through a provider network 20. The provider network 20 may be configured to transfer signals through any number of mediums, such as coaxial cable, hybrid fiber cable, terrestrial wireless, extraterrestrial wireless, infrared (IR), radio frequency (RF), and the like. Furthermore, the customer access points 12-14 may include transmitters, receivers, and the like for communication with the provider 16 as well as with other devices.

In accordance with one non-limiting aspect of the present invention, a remote control 24 may be provided to facilitate control of one or more of the customer access points 12-14. The remote control 24 may comprise any number of configurations and features, including being a television remote control, a mobile or cellular phone, a personal data assistant (PDA), or the like. Of course, the present invention contemplates the remote control 24 including any number of other configurations and is not intended to be limited to the foregoing examples.

In accordance with one non-limiting aspect of the present invention, the system 10 may include a secondary network 30 and secondary server 32. The secondary network 30 and server 32 may be associated with the provider 16, with an original equipment manufacturer (OEM) of the remote control 24, or other system provider. The secondary network 30 may include any communication medium and the server 32 may be configured to communicate signals transmitted from the remote control 24 to signals suitable for communication directly to the provider 16 and/or indirectly thereto by way of the provider network 32.

In accordance with one non-limiting aspect of the present invention, the remote control 24 may include a user interface 38 through which the user may interface with the remote control 24 to generate remote control signals and/or to receive information from the provider 16, server 32, and customer access point 12. In more detail, the user interface 38 may include a touch-screen display, a display and alphanumeric keypad, or other features that permit instructions, menus, or other items to be displayed to the user and/or which also permits the user to respond to such displays through touch screens, buttons, or the like.

The remote control 24 may include any number of features and configurations for exchanging signals with the customer access points 12-14 or other communication sources in communication therewith. In particular, the remote control 24 may be configured to transmit infrared (IR) or radio frequency (RF) signals to one or both of the customer access points 12-14 or network 30. For example, the remote control 24 may include an IR transmitter and receiver for exchanging IR signals with a STB and/or it may include an RF transmitter and receiver for exchanging cellular phone signals with the network 30. In this manner, the remote control 24 may communicate with the provider 16 through the customer access point 12 and/or the secondary network 30.

In accordance with one non-limiting aspect of the present invention, a user may control operation of the customer access point 12 through the user interface 38 of the remote control 24. In more detail, data associated with operation and control of the customer access point 12 may be transmitted from the provider 16 to the remote control 24 by way of customer access point 12 and/or the secondary network 30. The data may then be manipulated by the remote control 24 to provide menus and other similar features on the interface 38 for controlling operation of the customer access point 12.

For example, the remote control interface 38 may be configured to manipulate electronic programming guide (EPG) services associated with the customer access point 12, such as if the customer access point is a STB or other device configured to provide cable services. This allows the user to view the remote control interface 38 and make inputs thereto to control the remote control 24 to emit customer access unit control signals for controlling the customer access point 12 as function of menus and other items provided on the remote control interface 38, such as to permit the user to select programs, channels, and videos on demand (VOD) to view or download on or to the customer access point 12. The ability to provide EPG and other customer access related functionality on the remote control interface 38, which may be held by the user, may be particularly advantageous to assist users having difficulty viewing an EPG displayed on a television. Moreover, the present invention contemplates leveraging off of information displayed on the television EPG by providing highlighted or key-hole viewing of portions of the television EPG display on the remote control interface 38.

Likewise, the remote control interface 38 may be configured to control other operations associated with the customer access point 12, such as if the customer access point 12 has DVR capabilities. In more detail, the remote control interface 38 may be configured to display recording and other related DVR operations so that a user may remotely control the customer access point 12 to record, playback, or perform other recording related operations. This may be particularly advantageous if the remote control 24 is a cellular phone such that the user may simply use their cellular phone from any remote location to control DVR recording.

In this manner, the remote control interface 38 displays menus and other features related to functionality of the customer access point 12 such that the user may enter commands through the remote control interface 38 to control the remote control 24 as a function thereof, such as to emit control signals for controlling operation of the customer access point 12. The control signals may be communicated to the customer access point 12 directly from the remote control 24 with local transmission, i.e. IR or RF, and or indirectly over the secondary network 30 and server 32.

Of course, the present invention contemplates performing any number of other operations through the remote control user interface 38, including performing text searching of television programs, movies, and the like, and/or to conduct video conferencing, access the internet, and/or high speed data operations.

In accordance with one non-limiting aspect of the present invention, the data associated with the user interface 38 may be provided to the remote control 24 from the provider 16 by way of the provider network 20 and customer access point 12 and/or by way of the server 32 and secondary network 30. For example, if the customer access point 12 is a STB and the remote control 24 is a cellular phone, the provider 16 may provide EPG, DVR, or the data related signals over the provider network 20 to the STB for local transmission to the cellular phone whereby the cellular receives the locally transmitted data signals and configures the user interface 38 according to the received signals. Also, the provider 16 may provide the data signals through the server (cellular server) 32 which then converts the signals to those suitable for transmission over the secondary network (cellular network) 30 to the cellular phone whereby the cellular phone receives the cellularly transmitted data signals and configures the user interface 38 according to the received signals.

In accordance with one non-limiting aspect of the present invention, the remote control 24 may be of a type which is associable with a user so as to permit the customer access point 12, provider 16, or other to identify the user based on signals transmitted from the remote control 24. For example, the remote control 24 may be a cellular phone associated with a cellular phone number that may be dialed to deliver voice calls to the cellular phone such that the system 10 may associate the user with signals received from the cellular phone based on the associated cellular phone number. In this manner, the remote control interface 38 and functions controlled thereby may be customized to the user.

In accordance with one non-limiting aspect of the present invention, the provider 16, customer access points 12-14, or server 32 may include a data storage device or other feature for associating users with a remote control 24, such as in a look-up table. For example, when the remote control 24 is operational for controlling the customer access point 12, it may be configured to emit a request signals to the customer access point 12 and/or the network 30. The provider 16 and/or the customer access point 12 may then reply to the request with customized user interface data associated with the user of the remote control 24.

The associating of the user with the remote control may be completed with any number of operations. For example, the provider 16 may include operators or other personnel for programming the association into the data storage device based on a questionnaire or other information obtained from the user. Likewise, a web-page or automated message system may be set up that the user accesses through the remote control 24 to input their associated remote control identifier or which is electronically pulled from the remote control.

In accordance with one non-limiting aspect of the present invention, the user interface 38 automatically customizes its display based on an identity of the user. In this manner, the EPG functions, DVR functions, and other functions associated with the customer access point 12 may be tailored to the user. For example, a personal VOD folder may be associated with on demand movie selections of a user such that each time the user access a VOD menu of the EPG with the remote control 24 it provides a listing of the videos personally associated with the user. Likewise, a personal recording folder may be associated with DVR selections of a user such that each time the user access a DVR menu with the remote control 24 it provides a listing of the recordings personally associated with the user.

In this manner, the services may be customized to the user and displayed on the user interface 38 for immediate selection rather than requiring the user to navigate multiple generic menus of the customer access point 12. Of course, the present invention contemplates customizing the remote control interface 38 to the user according to any number of other functional aspects of the customer user interface and is not intended to be limited to customization related only to personal folders.

The present invention contemplates any number of features and configurations for supporting the customization of the user interface 38. In particular, the present invention contemplates storing the personal folders remotely on a data storage device associated with the provider 16 and/or locally on a data storage device associated with the customer access point 12. The location of the folders may be associated with the means for transmitting data signals to the remote control 24, i.e. dependent upon whether the data signals are transmitted from the customer access points 12-14 or secondary network 30.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of operating a customer access point, the method comprising:
associating a remote control with a user, the remote control configured to transmit signals to facilitate control of the customer access point; and
controlling a service associated with the customer access point as a function of the user associated with the remote control.

2. The method of claim 1 wherein the service is automatically controlled as a function of the user without requiring user interaction.

3. The method of claim 1 further comprising displaying a user interface on the remote control to facilitate transmitting signals from the remote control for controlling the customer access point.

4. The method of claim 3 further comprising displaying the user interface on a mobile phone.

5. The method of claim 4 further comprising associating the user with a mobile phone identifier associated with the mobile phone.

6. The method of claim 5 further comprising determining the mobile phone identifier to be a mobile phone number through which voice calls are communicated to the mobile phone.

7. The method of claim 3 wherein the customer access point is a settop box (STB) with an electronic programming guide (EPG) having selectable services, and wherein the method further comprises associating the remote control user interface with the EPG so that the user may select features from the remote control interface to control services associated with the EPG.

8. The method of claim 7 wherein at least one of the services associated with the EPG relates to video on demand (VOD), and wherein the method further comprises selecting videos from the remote control interface to add to a personal VOD folder associated with the user.

9. The method of claim 8 further comprising automatically displaying the personal VOD folder associated with the user on the remote control interface as a function of signals transmitted from the remote control so as to customize the remote control interface to the user.

10. The method of claim 8 further comprising automatically displaying the personal VOD folder associated with the user on the customer access point as a function of signals transmitted from the remote control so as to customize the customer access point to the user.

11. The method of claim 3 wherein the customer access point is a digital video recorder (DVR), and wherein the method further comprises associating the remote control user interface with the DVR so that the user may select features from the remote control interface to control services associated with the DVR.

12. The method of claim 11 further comprising selecting recordings from the remote control interface to add to a personal DVR folder associated with the user.

13. The method of claim 12 further comprising automatically displaying the personal DVR folder associated with the user on the remote control interface as a function of signals transmitted from the remote control so as to customize the remote control interface to the user.

14. The method of claim 12 further comprising automatically displaying the personal DVR folder associated with the user on the customer access point as a function of signals transmitted from the remote control so as to customize the customer access point to the user.

15. The method of claim 3 further comprising directly transmitting the signals from the remote control to the customer access points as a function of inputs received through the remote control user interface.

16. The method of claim 15 further comprising directly transmitting the signals from the remote control to the customer access point by emitting infrared (IR) or radio frequency (RF) from the remote control and receiving the signals with the customer access point.

17. The method of claim 3 further comprising indirectly transmitting the signals from the remote control to the customer access point as a function of inputs received through the remote control user interface.

18. The method of claim 17 further comprising indirectly transmitting the signals from the remote control to the customer access point by emitting signals from the remote control over a network to a provider network associated with the customer access point.

19. The method of claim 18 further comprising emitting the signals over a mobile phone network to the provider network.

20. The method of claim 18 further comprising emitting the signals over a voice over internet protocol (VoIP) network to the provider network.

21. The method of claim 3 further comprising providing data to the remote control to facilitate displaying the user interface on the remote control.

22. The method of claim 21 further comprising providing the data to the remote control with signals emitted from the customer access point.

23. The method of claim 21 further comprising providing the data to the remote control with signals emitted from a network associated with the remote control and not the customer access point.

24. The method of claim 21 further comprising providing the data to the remote control with signals emitted over a cellular phone network.

25. A method of selecting programs for viewing on a television, the method comprising:
providing signals to a mobile phone having a user interface for displaying a menu on the mobile phone interface through which a user selects a program for viewing on the television.

26. The method of claim 25 further comprising providing the signals to the mobile phone over a mobile phone network.

27. The method of claim 25 further comprising providing the signals to the mobile phone over a cellular phone network.

28. The method of claim 25 further comprising providing the signals to the mobile phone from a settop box (STB) associated with the television.

29. The method of claim 25 further comprising customizing the menu to the user based on signals emitted from the mobile phone so as to customize the menu to the user.

30. The method of claim 29 further comprising customizing the menu based on a telephone number associated with the mobile phone.

31. The method of claim 25 further comprising transmitting a control signal from the mobile phone to tune the television to the selected program based on inputs received through the mobile phone interface.

32. The method of claim 31 further comprising transmitting the control signal from the mobile phone directly to a settop box (STB) associated with the television to control the STB to tune the television to the selected program.

33. The method of claim 31 further comprising transmitting the control signal from the mobile phone by way of a mobile phone network to a settop box (STB) associated with the television to control the STB to tune the television to the selected program.

34. A method of controlling a settop box (STB), the method comprising:
providing user interface signals to a mobile phone for displaying a user interface on the mobile phone through which a user selects inputs for controlling operation of the STB; and
transmitting signals from the mobile phone based on inputs received through the mobile phone interface for controlling operation of the STB.

35. The method of claim 34 further comprising transmitting signals from the mobile phone to control a channel tuned to by the STB.

36. The method of claim 34 further comprising transmitting signals from the mobile phone to control programs recoded on a recorder associated with the STB.

37. The method of claim 34 further comprising automatically customizing the user interface based on a user of the mobile phone so as to customize the user interface to the user.

38. A system of providing services to at least one customer access point, the system comprising:
a provider configured to transmit signals to the customer access point related to services associated therewith;
a remote control configured to remotely control operation of the customer access point according to user inputs received through a remote control user interface; and
wherein the provider is further configured to transmit interface signals for controlling information displayed on the remote control user interface such that the inputs received through the remote control user interface to control operation of the customer access point are a function of the interface signals trasnmit by the provider.

39. The system of claim 38 wherein the provider is a cable provider configured to provide cable services.

40. The system of claim 38 wherein the remote control is a mobile phone.

41. The system of claim 38 wherein the remote control is a personal data assistant (PDA).

42. The system of claim 38 wherein the customer access point is a settop box (STB) such that channels tuned to by the STB are controlled by the remote control.

43. The system of claim 42 wherein the STB includes a digital video recorder (DVR) such that recording on the DVR is controlled by the remote control.

44. The system of claim 38 wherein the remote control user interface is customized as a function of a phone number associated with the remote control.

45. The system of claim 38 wherein remote control user interface is customized as a function of a user thereof.

46. The system of claim 38 wherein the remote control is configured to transmit signals directly to the customer access point to control the operation thereof.

47. The system of claim 38 wherein the remote control is configured to transmit signals over a phone network to control the operation of the customer access point.
